(19) United States
(12) Patent Application Publication
(10) Pub. No.: US 2014/0293655 A1
(43) Pub. Date: Oct. 2, 2014

(54) REACTOR, CONVERTER, AND POWER CONVERTER APPARATUS

(71) Applicant: Kazuhiro Inaba, Osaka-shi (JP)

(72) Inventor: Kazuhiro Inaba, Osaka-shi (JP)

(73) Assignees: autoNetworks Technologies, Ltd., Yokkaichi-shi (JP); Sumitomo Electric Industries., Ltd., Osaka-shi (JP)

(21) Appl. No.: 14/233,714

(22) PCT Filed: Jun. 18, 2012
(86) PCT No.: PCT/JP2012/065506

§ 371 Date: Jan. 17, 2014

(30) Foreign Application Priority Data
Jul. 20, 2011 (JP) 2011-159348

(51) Int. Cl. H01F 27/02; H02M 3/24; H01F 3/08

(52) U.S. Cl. CPC H01F 27/02; H01F 3/08; H02M 3/24
USPC 363/15; 336/90

(57) ABSTRACT

A reactor 1A of the present invention includes a sleeve-like coil 2, a magnetic core 3A having an inner core portion 31 disposed inside the coil 2 and an outer core portion 32A disposed outside the coil 2 to form a closed magnetic path with the inner core portion 31, and a case 4 storing the coil 2 and the magnetic core 3A. The case 4 is made of non-magnetic metal such as aluminum, and structured by a pair of bottomed sleeve-like bottomed case pieces 41 and 42. The outer core portion 32A is a mold product (a hardened mold product) of a mixture of magnetic powder and resin, and integrally molded with the bottomed case pieces 41 and 42. Since the case 4 and the outer core portion 32A are integrally molded, they exhibit excellent adhesion, and consequently, the heat dissipating characteristic of the reactor 1A can be enhanced. Further, since the case 4 and the outer core portion 32A are integrally molded, excellent assemblability is exhibited, and consequently, excellent productivity is also achieved.

### TECHNICAL FIELD

The present invention relates to a reactor used as a constituent component of a power converter apparatus such as an in-vehicle DC-DC converter, a converter including the reactor, and a power converter apparatus including the converter. In particular, the present invention relates to a reactor with excellent heat dissipating characteristic and productivity.

### BACKGROUND ART

A reactor is one of the components of a circuit that performs a voltage step up or step down operation. For example, Patent Literatures 1 and 2 disclose a reactor that is used for a converter mounted on a vehicle such as a hybrid vehicle. The reactor includes one sleeve-like coil and a magnetic core. The magnetic core is a so-called pot-type core, which includes an inner portion disposed inside the coil, and an outer portion that substantially entirely covers the opposite end faces and outer circumferential face of the coil, to form a closed magnetic path with the inner portion. Further, Patent Literatures 1 and 2 disclose, as the constituent material of the outer portion, a hardened mold product that is obtained by subjecting mixture fluid of magnetic powder and resin with flowability to molding process, and thereafter allowing the resin to cure.

### CITATION LIST

### Patent Literatures

Patent Literature 1: Japanese Patent No. 4692768

Patent Literature 2: Japanese Unexamined Patent Publication No. 2009-033051

### SUMMARY OF INVENTION

### Technical Problem

It is desired to enhance the heat dissipating characteristic of a reactor.

As a method for enhancing the heat dissipating characteristic of the reactor described in Patent Literatures 1 and 2, for example, the reactor should be stored in a case made of a material with excellent thermal conductivity such as aluminum, to use the case as a heat dissipation path. However, for example, when the magnetic core disposed inside and outside the coil such as the one disclosed in Patent Literature 1 is one integrated element, the shrinkage amount of the hardened mold product when cured tends to become great. Accordingly, even when the hardened mold product is stored in the case, because of a dimension error or the like, a clearance is produced between the hardened mold product and the case. Thus, the hardened mold product and the case cannot be closely brought into contact with each other, and it is difficult to fully enhance the heat dissipating characteristic. In order to allow the case and the hardened mold product to be closely brought into contact with each other, they may be joined to each other by an adhesive agent. However, in this situation, the number of steps increases, whereby a reduction in productivity is invited.

For example, employing a method in which a mold assembly described in Patent Literature 1 is replaced by the case, and a hardened mold product is manufactured by directly pouring the mixture fluid into the case, i.e., so-called cast molding, adhesion between the case and the hardened mold product can be enhanced. However, when the mixture fluid is poured in the state where the coil is stored in the case, the position of the coil relative to the case may be displaced until the resin cures. Accordingly, in order to fix the coil at a prescribed position of the case, a fixing jig or the like must be separately disposed, and an increase in the number of steps is invited. Further, in this mode, since the magnetic core disposed inside and outside the coil is one integrated element, it takes time to pour the raw material into the case, and also to allow the mixture to cure, and hence productivity is poor.

Accordingly, an object of the present invention is to provide a reactor with excellent heat dissipating characteristic and productivity. Further, another object of the present invention is to provide a converter including the reactor, and a power converter apparatus including the converter.

### Solution to Problem

The present invention achieves the objects by employing the structure in which the case is in a dividable structure, and a divided case piece of a particular shape is integrally molded with a portion of the magnetic core, which portion is disposed outside the coil.

A reactor according to the present invention includes a sleeve-like coil; a magnetic core that has an inner core portion disposed inside the coil and an outer core portion disposed outside the coil, the outer core portion forming a closed magnetic path with the inner core portion; and a case that stores the coil and the magnetic core. The case is structured by a combination of a plurality of divided case pieces made of a non-magnetic metal. Two of the plurality of divided case pieces are each a bottomed sleeve-like bottomed case piece. The outer core portion is a mold product of a mixture of magnetic powder and resin, and the outer core portion includes integrated mold products respectively integrally molded with the bottomed case pieces.

The “outside the coil” is at least one of the end face side of the coil and the outer circumferential face side of the coil.

In the reactor of the present invention, the outer core portion is a mold product of the mixture, i.e., a hardened mold product. The reactor includes, as constituent elements, members in which at least two divided case pieces structuring the case are each integrally molded with at least a portion (the integrated mold product) of the outer core portion. That is, the reactor includes core-case integrated members in each of which part of the magnetic core and part of the case are integrated. In connection with the core-case integrated members, since at least part of the outer core portion and the case exhibit excellent adhesion, the reactor of the present invention has an excellent heat dissipating characteristic even when the magnetic core and the case are not joined to each other by an adhesive agent or the like. Since it is not necessary to perform joining using an adhesive agent, the number of steps can be reduced. Thus, the reactor of the present invention also exhibits excellent productivity.

Further, being different from the situation where the outer core portion is molded in the state where the coil is stored in the case, with the reactor of the present invention, the outer core portion and the coil can be manufactured independently of each other. Accordingly, it is not necessary to dispose a jig for fixing the coil to the divided case pieces in manufacturing the outer core portion. Further, similarly to the case, the outer core portion is also in a dividable structure, and dividable elements can be manufactured simultaneously. Therefore, as compared to the situation where the magnetic core is one integrated element, the manufacturing time (the packing time or the curing time of the raw material) of the magnetic core can be reduced. In particular, in molding the outer core portion, employing the manufacturing scheme according to which mixture fluid can be packed at high speeds in a mold assembly (including the bottomed case pieces in the present invention), such as injection molding, a further reduction in manufacturing time can be achieved. Thanks to these points also, the reactor of the present invention exhibits excellent productivity.

Further, in connection with the reactor of the present invention, since the outer core portion is a hardened mold product, it can be easily molded even in a complicated shape. For example, it is possible to employ a mode in which the integrated mold product has the inner circumferential shape that conforms to the outer shape of the coil. In this mode, positioning of the coil and the magnetic core can be performed with ease, and excellent assemblability is exhibited. Thanks to these points also, the reactor of the present invention exhibits excellent productivity.

In addition, since the reactor of the present invention has two bottomed case pieces made of non-magnetic metal, a wide region of the outer core portion is covered by the case. Preferably, the outer core portion is substantially entirely covered by the case. Accordingly, the following effects are achieved: (1) the magnetic flux does not easily leak outside the case, and any leakage flux can be suppressed; and (2) protection from the environment and mechanical protection can be provided to the outer core portion.

As one mode of the reactor of the present invention, the bottomed case pieces can be separated in a radial direction of the coil.

In the mode described above, the integrated mold product integrally molded with the bottomed case piece at the outer core portion is also separated in the radial direction of the coil. Accordingly, the seam portion of the integrated mold product can be disposed easier in parallel to the axis of the coil. Here, in the mode where the seam portion of the divided pieces structuring the magnetic core is disposed perpendicularly to the axis of the coil, an inevitable clearance is produced between the divided pieces. The clearance is present in a manner whereby the magnetic flux is broken. Therefore, with this mode, it can be understood that an inevitable gap is interposed, whereby a reduction in the magnetic characteristic, such as generation of a leakage flux, may be invited. According to the mode described above, since the gap breaking the magnetic flux can be reduced, or the gap breaking the magnetic flux substantially does not exist, an excellent magnetic characteristic is also obtained.

As one mode of the present invention, the sleeve-like coil is included by one in number, and at least one of the integrated mold products includes portions that partially cover end faces of the coil, and a portion that partially covers an outer circumferential face of the coil.

With the mode described above, a reduction in size can be achieved easier as compared to the mode in which a pair of coil elements is included (FIG. 7 of Patent Literature 1), and the mode described above is preferable for uses such as an in-vehicle component with which a reduction in size and weight is desired. Further, since at least one integrated mold product includes the particular portion that extends from one end face of the coil to cover other end face of the coil via the outer circumferential face of the coil, that is, the portion having a Π-shaped cross section, the integrated mold product does not break the magnetic flux formed by the coil midway, but allows the magnetic flux to pass from the one end face side of the coil to the other end face side via the outer circumferential face side of the coil. Accordingly, with the mode described above, an excellent magnetic characteristic is obtained.

As one mode of the reactor of the present invention, the outer core portion includes an independent core piece that can be fitted to the integrated mold product.

The independent core piece can be molded into any shape. By combining such an independent core piece and the integrated mold product, for example, the outer surface of the coil of any shape can be surely covered by the outer core portion. Accordingly, with the mode described above, flexibility of the shape of the coil and the outer core portion can be increased.

As one mode of the reactor of the present invention, the bottom face of one bottomed case piece is a cooling face that is disposed to be in contact with the installation target.

The reactor is used as being attached to the installation target such as, representatively, a cooling table. With the mode described above, the bottom face of the bottomed case piece serves as the contact face relative to the installation target, and the seam portion of the bottomed case pieces is not disposed on the installation target. That is, with the mode described above, the seamless face can serve as the cooling face. Hence, an excellent heat dissipating characteristic is obtained.

The reactor of the present invention can be suitably used as a constituent component of a converter. As a converter of the present invention, the converter includes: a switching element; a driver circuit that controls an operation of the switching element; and a reactor that smoothes a switching operation, wherein the converter converts an input voltage by the operation of the switching element, and the reactor is the reactor according to the present invention. The converter of the present invention can be suitably used as a constituent component of a power converter apparatus. As a power converter apparatus of the present invention, the power converter apparatus includes: a converter that converts an input voltage; and an inverter that is connected to the converter and that performs interconversion between a direct current and an alternating current, wherein the power converter apparatus drives a load by power obtained by conversion of the inverter, and the converter is the converter according to the present invention.

Since the converter of the present invention and the power converter apparatus of the present invention include the reactor of the present invention, excellent heat dissipating characteristic and productivity are exhibited.

### Advantageous Effects of Invention

The reactor of the present invention exhibits excellent heat dissipating characteristic and productivity. Since the converter of the present invention and the power converter apparatus of the present invention include the reactor of the present invention with excellent productivity, they exhibit excellent heat dissipating characteristic and productivity.

### BRIEF DESCRIPTION OF DRAWINGS

FIG. 1 (A) is a schematic perspective view of a reactor according to a first embodiment; FIG. 1 (B) is a cross-sectional view taken along line (B)-(B) shown in FIG. 1 (A); and FIG. 1 (C) is a cross-sectional view taken along line (C)-(C) shown in FIG. 1 (A).

FIG. 2 (A) is an exploded perspective view of the reactor according to the first embodiment; and FIG. 2 (B) is a perspective view of one core-case integrated member included in the reactor as seen from the outer core portion side.

FIG. 3 is a schematic perspective view of a reactor according to a second embodiment.

FIG. 4 is an exploded perspective view of the reactor according to the second embodiment.

FIG. 5 is a schematic perspective view of one core-case integrated member included in the reactor according to the second embodiment as seen from the outer core portion side, and a perspective view of an independent core piece.

FIG. 6 is a schematic configuration diagram schematically showing a power supply system of a hybrid vehicle.

FIG. 7 is a schematic circuit diagram showing one example of a power converter apparatus of the present invention including the converter of the present invention.

### DESCRIPTION OF EMBODIMENTS

In the following, a specific description will be given of embodiments of the present invention with reference to the drawings. Throughout the drawings, identical reference signs denote identically named elements.

### First Embodiment

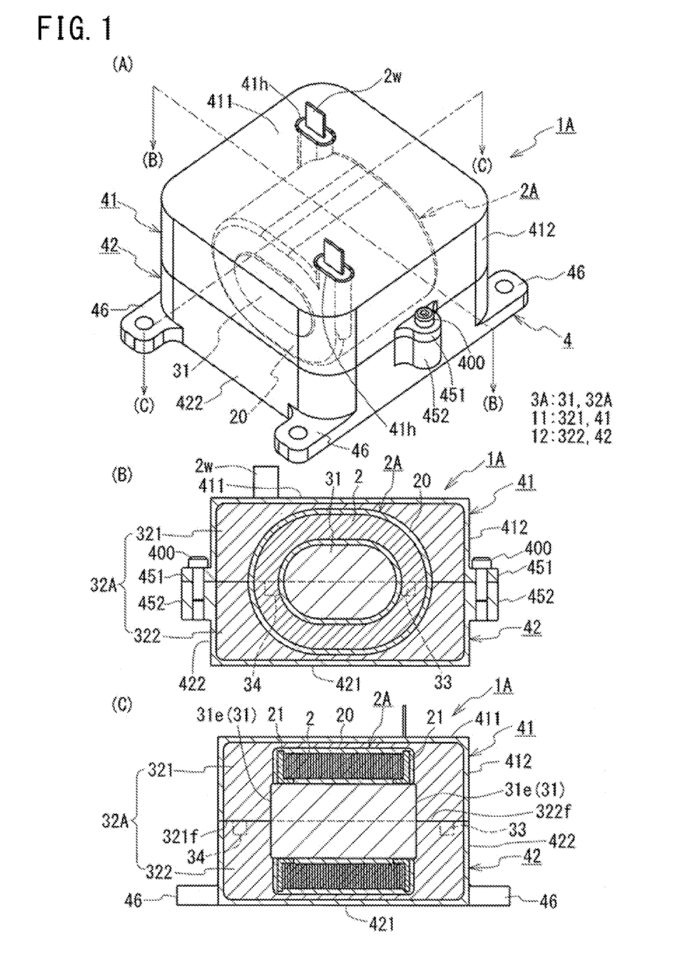

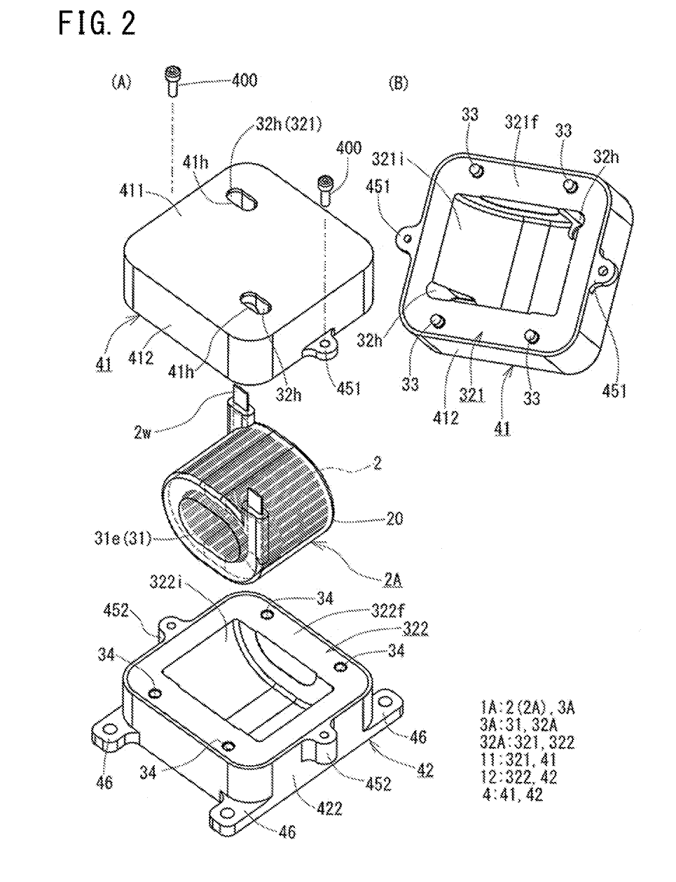

With reference to FIGS. 1 and 2, a description will be given of a reactor 1A according to a first embodiment. The reactor 1A is representatively used as a circuit component as being installed on an installation target, such as a cooling table that is made of metal (representatively, made of aluminum) and that includes a circulation path (not shown) of coolant. The reactor 1A includes one sleeve-like coil 2 made of a wound wire 2w, a magnetic core 3A disposed inside and outside the coil 2 to form a closed magnetic path, and a case 4 storing the coil 2 and the magnetic core 3A. The magnetic core 3A includes an inner core portion 31 disposed inside the coil 2 and an outer core portion 32A disposed outside the coil 2. The outer core portion 32A is structured by a mold product of a mixture containing magnetic powder and resin, i.e., a hardened mold product.

The reactor 1A is characterized in that the case 4 is in a dividable structure, and the mixture structuring the outer core portion 32A is integrally molded with the case piece. In accordance with the structure, the outer core portion 32A is also in a dividable structure. Here, the reactor 1A includes, as constituent elements, two core-case integrated members 11 and 12 in which the outer core portion 32A and the case 4 are integrated. The core-case integrated members 11 and 12 respectively include bottomed sleeve-like bottomed case pieces 41 and 42. To the bottomed case pieces 41 and 42, a mixture (integrated mold products 321 and 322, respectively) structuring the outer core portion 32A is integrally molded. Further, herein, the reactor 1A includes a coil mold product 2A in which the coil 2 and the inner core portion 31 are integrally retained by the resin mold portion 20. Accordingly, the reactor 1A is structured by one coil mold product 2A and two core-case integrated members 11 and 12. In the following, a detailed description will be given of the coil mold product 2A and the core-case integrated members 11 and 12.

[Coil Mold Product]

The coil mold product 2A includes a resin mold portion 20 that retains the shape of the coil 2 and that is made of an insulating resin that integrally retains the coil 2 and the inner core portion 31. When the reactor 1A is assembled, the coil 2 is not expanded or compressed and thus the coil mold product 2A can be handled with ease. Furthermore, the coil 2 and the inner core portion 31 can be handled as one component. Accordingly, with the reactor 1A, a reduction in the number of components and the number of steps in assembling, and an improvement in assemblability can be achieved. Further, since the resin mold portion 20 is included, insulation between the coil 2 and the magnetic core 3A can also be enhanced.

<Coil>

The coil 2 is a sleeve-like element, which is made of one continuous wire 2w being spirally wound. As the wire 2w, a coated wire including a conductor made of a conductive material such as copper, aluminum, or alloy thereof may be preferably used. The conductor is provided with an insulating coat made of an insulating material at its outer circumference. The conductor may be of a variety of shape, such as a rectangular wire whose cross-sectional shape is rectangular, a round wire whose cross-sectional shape is circular, or a deformed wire whose cross-sectional shape is polygonal, elliptical or the like. The thickness (cross-sectional area) or the number of turns or the like of the wire 2w can be selected as appropriate.

The end face shape of the coil 2 may be, for example, the shape whose contour is a curve (the outer circumferential face of the coil 2 is made of a curved surface) such as a ring-like shape or an elliptical ring-like shape (the center in the end face is the center of the ellipse), the shape whose contour is a combination of curves and straight lines (the outer circumferential face of the coil 2 is a curved surface and a flat surface) such as a rounded shape being a rounded quadrangular frame (the center in the end face is the intersection of diagonal lines), a racetrack shape made of a combination of semicircles and straight lines (the center in the end face is the intersection of the diagonal lines in a quadrangle formed by arcs of the semicircles and the straight lines). When at least part of the outer circumferential face of the coil 2 is a curved surface, the wire 2w can be wound around easier and hence excellent manufacturability of the coil is achieved. When part of the outer circumferential face of the coil 2 is a flat surface, arranging this flat surface to be the face disposed on the installation target, the area opposing to the installation target can be increased easier, and the heat dissipating characteristic can be enhanced or stability of the installation state can be enhanced.

Herein, the coil 2 is an edgewise coil formed by a coated rectangular wire wound edgewise. The coated rectangular wire includes a rectangular wire made of copper whose cross-sectional shape is rectangular and which is provided with an insulating coat made of enamel (representatively, polyamide-imide). Further, the end face shape of the coil 2 (which is equivalent to the cross-sectional shape of the coil 2 taken along a plane being perpendicular to the axial direction (FIG. 1 (B))) is a racetrack shape. Further, the coil 2 is disposed such that its axial direction is parallel to the surface of the installation target when the reactor 1A is installed on the installation target (hereinafter, this disposition is referred to as the horizontal disposition).

The wire 2w forming the coil 2 has drawn out portions that are drawn out as appropriate from the turn forming portion. As shown in FIG. 1 (A), the opposite end portions of the wire 2w are drawn out to the outside of the case 4, each having the insulating coat stripped off therefrom. To the exposed conductor portion, a terminal member (not shown) made of a conductive material such as copper or aluminum is connected using welding such as TIG welding, fixation under pressure or the like. Via the terminal member, an external apparatus (not shown) such as a power supply that supplies power to the coil 2 is connected. In the example shown in FIG. 1, though the opposite end portions of the wire 2w are drawn out perpendicularly to the axial direction of the coil 2, the draw-out direction of the opposite end portions can be selected as appropriate. For example, the opposite end portions of the wire 2w can be drawn out in parallel to the axial direction of the coil 2. Alternatively, the draw-out direction or the position in the axial direction of the coil may be different between the opposite end portions.

<Inner Core Portion>

The inner core portion 31 forms a closed magnetic path with the outer core portion 32A when the coil 2 is excited. Herein, the inner core portion 31 is a columnar element whose outer shape is a racetrack shape conforming to the inner circumferential shape of the coil 2. Further, the inner core portion 31 is inserted and disposed into the coil 2, and the opposite end faces 31e and the area nearby respectively slightly project from the end faces of the resin mold portion 20 of the coil mold product 2A. In this state, the inner core portion 31 is retained integrally with the coil 2 by the resin structuring the resin mold portion 20.

Similarly to the outer core portion 32A, the inner core portion 31 may be a hardened mold product. Here, the component of the inner core portion 31 may be identical to or different from that of the outer core portion 32A. Alternatively, the inner core portion 31 may be structured by a constituent material totally different from that of the outer core portion 32A. By being structured by different materials, the magnetic characteristic of the magnetic core 3A can be partially varied. Herein, the inner core portion 31 is structured entirely by a powder magnetic core, and higher in saturation magnetic flux density than the outer core portion 32A. The outer core portion 32A is lower in permeability than the inner core portion 31.

Representatively, the powder magnetic core is obtained by molding soft magnetic powder provided with an insulating coating on its surface or mixed powder, which is a mixture of the soft magnetic powder and a binder being appropriately added; and thereafter baking the soft magnetic powder or the mixed powder at the temperature equal to or lower than the heat resistant temperature of the insulating coating. Herein, the soft magnetic powder provided with an insulating coat is used.

The soft magnetic powder may be iron group metal such as Fe, Co, Ni, Fe-base alloy powder whose main component is Fe such as Fe—Si, Fe—Ni, Fe—Al, Fe—Co, Fe—Cr, and Fe—Si—Al, rare-earth metal powder, ferrite powder and the like. In particular, with the iron base material, a magnetic core with a high saturation magnetic flux density can be obtained easier than with ferrite. The insulating coating formed at the soft magnetic powder may be, for example, a phosphate compound, a silicon compound, a zirconium compound, an aluminum compound, or a boron compound. When the insulating coat is provided particularly when the magnetic particles structuring the magnetic powder is made of metal such as iron group metal or Fe-base alloy, the eddy current loss can be effectively reduced. The binder may be, for example, thermoplastic resin, non-thermoplastic resin, or higher fatty acid. The binder may be vanished by the baking, or may change into an insulating substance such as silica. The powder magnetic core in which an insulating substance such as the insulating coating is present among the magnetic particles can reduce the eddy current thanks to insulation among the magnetic particles, even when the coil is energized with high-frequency power, and thus a loss can be reduced. Any known powder magnetic core can be used. Using the soft magnetic powder of a high saturation magnetic flux density, increasing the proportion of the soft magnetic material by reducing the blending amount of the binder, or increasing the molding pressure, a powder magnetic core with a high saturation magnetic flux density can be obtained.

Herein, the saturation magnetic flux density of the inner core portion 31 is 1.6 T or more and 1.2 times as great as the saturation magnetic flux density of the outer core portion 32A or greater; the relative permeability of the inner core portion 31 is 100 to 500; and the relative permeability of the whole magnetic core 3A is 10 to 100. The saturation magnetic flux density of the inner core portion 31 is preferably 1.8 T or more, and further preferably 2 T or more. Preferably, the saturation magnetic flux density of the inner core portion 31 is 1.5 times, and further preferably 1.8 times, as great as the saturation magnetic flux density of the outer core portion 32A or greater. Using the lamination product of electromagnetic steel sheets as being represented by silicon steel plates in place of the powder magnetic core, the saturation magnetic flux density of the inner core portion can be increased further easier.

Further, herein, the inner core portion 31 is a solid element with no gap member or air gap being interposed. It is also possible that a gap member made of a non-magnetic material such as an alumina plate or an air gap is interposed.

The axial direction length of the coil 2 in the inner core portion 31 (hereinafter simply referred to as the length) and the projection length projecting from the end face of the coil 2 can be selected as appropriate. Herein, the end faces 31e of the inner core portion 31 respectively project from the end faces of the coil 2, and the projection length is identical between the end faces 31e (the length of the inner core portion 31>the length of the coil 2). On the other hand, when the end faces 31e of the inner core portion 31 and the end faces of the coil 2 are flush (the length of the inner core portion 31=the length of the coil 2), or when one end face of the inner core portion 31 is flush with one end face of the coil 2 and other end face of the inner core portion 31 projects from other end face of the coil 2 (the length of the inner core portion 31>the length of the coil 2, i.e., the projection length is different), a low-loss characteristic can be achieved. In any of the foregoing modes, the outer core portion 32A is included such that a closed magnetic path is formed when the coil 2 is excited.

As described above, since the reactor 1A is in the horizontal disposition, when the reactor 1A is fixed to the installation target, the inner core portion 31 is disposed such that its axial direction is also parallel to the surface of the installation target.

<Resin Mold Portion>

As the resin structuring the resin mold portion 20, what is preferably used is an insulating material that has the heat resistance with which the resin does not soften when the maximum temperature of the coil 2 or the magnetic core 3A is reached during operation of the reactor 1A, and that can be subjected to transfer molding or injection molding. The exemplary resin may be thermosetting resin such as epoxy resin, or thermoplastic resin such as polyphenylene sulfide (PPS) resin and liquid crystal polymer (LCP). Herein, epoxy resin is used. As the resin structuring the resin mold portion 20, employing the resin containing a filler made of at least one type of ceramic selected from silicon nitride, alumina, aluminum nitride, boron nitride, and silicon carbide, a reactor with an excellent heat dissipating characteristic can be obtained.

The thickness of the resin mold portion 20 can be selected as appropriate so as to satisfy the desired insulating characteristic, e.g., approximately 0.1 mm to 10 mm. As the resin mold portion 20 is thinner, the heat dissipating characteristic can be improved (preferably 0.1 mm to 3 mm), and as it is thicker, the insulating performance and strength of the coil mold product 2A can be improved. Herein, as shown in FIGS. 1 (B) and 1 (C), the thickness is substantially uniform.

Herein, as shown in FIG. 2, since the resin mold portion 20 covers the entire outer surface of the coil 2 except for the opposite end portions of the wire 2w, insulation between the drawn out portions and the outer core portion 32A can be also secured. On the other hand, when the drawn out portions including the opposite end portions of the wire 2w are exposed outside the resin mold portion, the outer shape of the resin mold portion is simplified and hence the coil mold product can be molded easier. Furthermore, the coil mold product can be reduced in size easier. In this mode, in connection with any part in the drawn out portions of the wire 2w that may possibly be brought into contact with the magnetic core 3A (the outer core portion 32A), disposing an insulating member such as an insulating paper, an insulating tape (e.g., a polyimide tape), an insulating film (e.g., a polyimide film) to such a part, subjecting the part to dip coating of an insulating member, or covering the part by an insulating tubing (a heat shrink tubing, a cold shrink tubing or the like), insulation between the drawn out portions and the outer core portion 32A can be secured. It is also possible to cover at least one of the end faces 31e of the inner core portion 31 by the resin mold portion 20.

Providing the resin mold portion 20 with a function of retaining the coil 2 in the compressed state relative to its free length, the axial direction length of the coil 2 can be shortened, and the coil mold product 2A can be reduced in size.

The reactor 1A further includes bobbins 21 (FIG. 1 (C)). The bobbins 21 are each an annular member having an L-shaped cross section including a short sleeve-like element disposed at the outer circumference of the inner core portion 31, and a plurality of flat plate-like flange portions projecting outward from the periphery of the sleeve-like element. The bobbins 21 are structured by an insulating resin such as PPS resin, LCP, polytetrafluoroethylene (PTFE) resin, and function, with the resin mold portion 20, as the insulating members for enhancing insulation between the coil 2 and the inner core portion 31. Further, the bobbins 21 function as the positioning members for the inner core portion 31 with reference to the coil 2, and the retaining members of the coil 2. Herein, two bobbins 21 are prepared, and as shown in FIG. 1 (C), the bobbins 21 are respectively disposed near the end faces 31e of the inner core portion 31, and the flange portions of each bobbin 21 abut on the end face of the coil 2.

<Manufacturing Method>

The coil mold product 2A including the inner core portion 31 can be manufactured according to, for example, the manufacturing method described in Japanese Unexamined Patent Publication No. 2009-218293 (note that the core should be replaced by the inner core portion 31). Specifically, a mold assembly that can be opened and closed, and that includes a holding rod integrally provided inside the mold assembly or a plurality of pressing rods capable of advancing and retracting relative to the mold assembly is prepared. After disposing the coil 2 and the inner core portion 31 in the mold assembly, the flange portions of the bobbins 21 are held by the holding rod, or the flange portions are pressed by the pressing rods to thereby compress the coil 2. In this state, resin is poured into the mold assembly and allowed to solidify. Since the reactor 1A includes the bobbins 21, the coil 2 and the inner core portion 31 can be stored in the mold assembly in the state where a prescribed interval (the interval corresponding to the thickness of the sleeve-like elements of the bobbins 21) is secured between the coil 2 and the inner core portion 31, and the interval can be retained. Thus, the resin mold portion 20 can be manufactured to have a uniform thickness with ease, and excellent manufacturability of the coil mold product 2A is exhibited.

Note that, the coil mold product can be structured such that the inner core portion 31 can be separated, i.e., the coil mold product may be structured by the coil and the resin mold portion. This coil mold product has a hollow hole formed by the resin structuring the resin mold portion, and the inner core portion is inserted and disposed into the hollow hole. This coil mold product can be manufactured by disposing a core of a prescribed shape in the mold assembly, in place of the inner core portion.

[Core-Case Integrated Members]

The core-case integrated members 11 and 12 are solids whose outer shape becomes a rectangular parallelepiped-shape as shown in FIG. 1 (A) when combined with each other. The outer surface is formed by the bottomed case pieces 41 and 42 structuring the case 4. The core-case integrated members 11 and 12 are halved pieces obtained by cutting the solid of the rectangular parallelepiped-shape along a plane passing through the axis of the coil 2. Herein, the core-case integrated members 11 and 12 can be separated in the radial direction of the coil 2. That is, each of the integrated mold products 321 and 322 structuring the outer core portion 32A and the bottomed case pieces 41 and 42 structuring the case 4 is a halved piece obtained by cutting along the plane passing through the axis of the coil 2, and can be separated in the radial direction of the coil 2. Further, herein, when the reactor 1A is installed on the installation target, the bottom faces of the bottomed case pieces 41 and 42 (the surface of the bottom portions 411 and 421) are disposed in parallel to the surface of the installation target, and the core-case integrated members 11 and 12 are separated in the direction perpendicular to the surface of the installation target.

<Outer Core Portion>

Firstly, a description will be given of the shape of the outer core portion 32A. The outer core portion 32A is structured by a combination of two integrated mold products 321 and 322 each being a hardened mold product. The integrated mold products 321 and 322 are disposed to cover the outer circumferential face and opposite end faces of the coil mold product 2A (the opposite end faces 31e of the inner core portion 31 and the end faces of the resin mold portion 20). Thus, the outer core portion 32A includes therein the coil mold product 2A.

The integrated mold products 321 and 322 are each a bottomed square sleeve-like element in which the horizontal cross section taken along a plane being perpendicular to the axial direction of the coil 2 (FIG. 1 (B)) and the vertical cross section taken along a plane being parallel to the axial direction of the coil 2 (FIG. 1 (C)) are both Π-shaped. In the integrated mold products 321 and 322, the region covered by the bottomed case pieces 41 and 42 and not being exposed is in the shape conforming to the inner circumferential shape of the bottomed case pieces 41 and 42 (herein, the rectangular parallelepiped-shape). As shown in FIG. 2, the exposed region includes contact faces 321i and 322i relative to the coil mold product 2A and opposing faces 321f and 322f disposed to oppose to each other. The contact faces 321i and 322i are in the shape conforming to the shape of the outer circumferential face and end faces of the coil mold product 2A. As shown in FIG. 2, the opposing faces 321f and 322f are substantially structured by flat surfaces. Herein, the opposing faces 321f and 322f serve as the joining faces being joined when the integrated mold products 321 and 322 are combined with each other.

The outer core portion 32A may be in any shape so long as a closed magnetic path is formed. The inner circumferential shape of the bottomed case pieces 41 and 42 or the like can be changed as appropriate such that the outer core portion 32A assumes a desired shape. For example, the shape may be similar to the outer shape of the coil 2. Alternatively, part of the coil 2 (herein, the coil mold product 2A) may be exposed to be brought into contact with the bottomed case pieces 41 and 42.

The contact faces 321i and 322i of the integrated mold products 321 and 322 are each structured by a face to be brought into contact with part of the outer circumferential face (herein, half the circumference) of the coil mold product 2A and the face to be brought into contact with part (herein, half) of the end faces of the coil mold product 2A (herein, the end faces 31e of the inner core portion 31 and the end faces of the resin mold portion 20). With the coil mold product 2A, since the inner core portion 31 projects further than the end faces of the resin mold portion 20, the contact faces 321i and 322i are each in a concave-convex shape such that the projecting inner core portion 31 is fitted thereto. In this manner, the integrated mold products 321 and 322 each include a portion covering part of the outer circumferential face of the coil mold product 2A and part of the end faces of the coil mold product 2A. In addition, when the outer surface of the coil mold product 2A is in a concave-convex shape and the contact faces 321i and 322i are each provided with a convex-concave portion conforming to the concave and convex, the coil mold product 2A can be easily positioned relative to the core-case integrated members 11 and 12.

The thickness of the integrated mold products 321 and 322 can be selected as appropriate so long as a prescribed magnetic path area is secured. Herein, as shown in FIG. 1 (B), the thickness of the portions of the outer circumferential face of the coil 2 structured by flat surfaces, that is, the portion covering the portion on the installation target side when the reactor 1A is installed on the installation target and the portion on the side opposite thereto is smaller than the thickness of the portions covering the portions of the outer circumferential face of the coil 2 structured by curved surfaces. Accordingly, when the reactor 1A is installed on the installation target, as shown in FIGS. 1 (B) and 1 (C), the coil 2 is disposed in close proximity to the installation target and the distance between the coil 2 and the installation target is short. Accordingly, the reactor 1A can easily transfer the heat of the coil 2 to the installation target, and thus has an excellent heat dissipating characteristic.

The opposing faces 321f and 322f of the integrated mold products 321 and 322 are structured with flat surfaces as described above, and substantially flush with the opening circumferential faces (which also serve as the joining faces herein) of the bottomed case pieces 41 and 42. Accordingly, the following advantages are obtained; (1) when the integrated mold products 321 and 322 are molded using the bottomed case pieces 41 and 42 as mold assemblies, the integrated mold products 321 and 322 can be molded easier without the integrated mold products 321 and 322 projecting from the bottomed case pieces 41 and 42; (2) molding can be easily performed thanks to the simplified shape of the integrated mold products 321 and 322; and (3) the opposing faces 321f and 322f of the integrated mold products 321 and 322 can be joined to each other and the opening circumferential faces of the bottomed case pieces 41 and 42 can be joined to each other, without the necessity of using an adhesive agent or the like.

Since the opposing faces 321f and 322f are flat surfaces, the seam portion of the integrated mold products 321 and 322 is formed as a straight line as shown in FIGS. 1 (B) and 1 (C). The seam portion is disposed in parallel to the surface of the installation target when the reactor 1A is installed on the installation target. In particular, since the straight line forming the seam portion is parallel to the straight line being present on the plane passing through the axis of the coil 2 (the straight line being parallel to the axial direction of the coil 2, and the straight line in the radial direction of the coil 2), the seam portion is disposed so as not to substantially break the magnetic flux created by the coil 2.

Further, the integrated mold products 321 and 322 shown in this example include engaging portions (engaging projections 33 and engaging holes 34) engaging with each other. Specifically, as shown in FIG. 2 (B), one integrated mold product 321 includes the engaging projections 33 projecting from the opposing face 321f, and other integrated mold product 322 includes the engaging holes 34 at the opposing face 322f. When the integrated mold products 321 and 322 are combined with each other, the engaging projections 33 fit into the engaging holes 34, and the integrated mold products 321 and 322 can be properly combined at a prescribed position. Herein, as shown in FIG. 2, the engaging projections 33 are formed as circular cylindrical elements and the engaging holes 34 are formed as circular holes, such that a plurality of engaging portions (at four places) are provided. However, one engaging portion solely may be provided. Further, the shape can be changed as appropriate also, to be prism elements, quadrangular holes and the like. Alternatively, the contact faces of the integrated mold products 321 and 322 may each be formed in a concave-convex shape such as a wavy shape or a zigzag shape, so that part of the seam portion of the integrated mold products 321 and 322 becomes curvy or zigzag. Then, this concave-convex shape portion can be used as an engaging portion. In this situation, when the corresponding portion at the wall portion of the bottomed case piece is also formed in a concave-convex shape, the integrated mold product can be molded easier, and furthermore, the contact area between the bottomed case pieces and the outer core portion can be increased.

As shown in FIG. 2, one integrated mold product 321 and one bottomed case piece 41 provided with the integrated mold product 321 are provided with continuous wire holes 32h and 41h, into which the end portions of the wire 2w of the coil 2 are inserted. The shape and size of the wire holes 32h and 41h are adjusted such that the end portions of the wire 2w can be inserted at the portions corresponding to the disposition positions of the end portions of the wire 2w at the integrated mold product 321 and the bottomed case piece 41. When each hole is formed to be fully greater than the end portion of the wire 2w, the wire 2w can be inserted with ease, and thus excellent insertion workability is exhibited.

Next, a description will be given of the material of the outer core portion 32A. As a method for manufacturing the hardened mold product, injection molding, transfer molding, MIM, cast molding, press molding using magnetic substance powder and solid resin powder or the like can be employed. With the injection molding, a mixture of powder of a magnetic substance material, i.e., magnetic powder, and resin is packed in a mold assembly under a prescribed pressure to be molded, and thereafter the resin is cured. With the transfer molding and the MIM also, a raw material is packed in a mold assembly under a prescribed pressure and molded. With the cast molding, after a mixture of magnetic powder and resin is obtained, the mixture is poured into a mold assembly with no application of pressure, and molded and cured. Since the raw material mixture can be quickly packed in the mold assembly with application of a prescribed pressure with the injection molding, the transfer molding, and the MIM, those methods exhibit excellent productivity, and can be suitably used particularly for mass production. Further, in the present invention, as part of the mold assembly, the bottomed case pieces 41 and 42 are used. Since the bottomed case pieces 41 and 42 are made of metal, they can fully serve as mold assemblies in any of the foregoing molding methods. Convex-shape mold assemblies that match to the bottomed case pieces 41 and 42 are prepared, such that the opposing faces 321f and 322f and the contact faces 321i and 322i of the integrated mold products 321 and 322 each assume a desired shape.

When the bottomed case piece 41 where the wire holes 41h are previously formed is used, in molding the integrated mold product 321, the wire holes 41h are closed by any appropriate material, and the material is removed after molding. After the integrated mold product 321 is molded, the wire holes 32h and 41h may be provided simultaneously by cutting work. When only the wire holes 32h are provided, hole-use projections may be provided at the convex-shape mold assembly to be matched to the bottomed case piece 41.

In any of the foregoing molding schemes, as the magnetic powder, the magnetic powder similar to the soft magnetic powder used for the inner core portion 31 described above can be used. In particular, for the soft magnetic powder used for the outer core portion 32A, iron base material such as pure iron powder or Fe-base alloy powder can be suitably used. It is also possible to use a plurality of types of magnetic powder of different materials as being mixed. Further, coated powder made of metal-made magnetic particles whose surface is provided with an insulating coating made of phosphate or the like can be used. In this situation, an eddy current loss can be reduced. As the magnetic powder, the powder whose average particle size is 1 μm or more and 1000 μm or less, or further, 1 μm or more and 200 μm or less can be conveniently used. A plurality of types of powder being different in particle size can be used. In this situation, a reactor with a high saturation magnetic flux density and low loss can be obtained easier.

Further, in any of the foregoing molding schemes, thermosetting resin such as epoxy resin, phenolic resin, silicone resin, urethane resin, and unsaturated polyester, and thermoplastic resin such as PPS resin and polyimide resin can be used as the resin serving as a binder. With epoxy resin, a hardened mold product with excellent strength can be obtained. With silicone resin, thanks to its softness, the hardened mold products can be joined to each other easier. When thermosetting resin is used, the mold product is heated such that the resin is thermally cured. When the thermoplastic resin is used, it is solidified at appropriate temperatures. Room temperature curing resin or low temperature curing resin can be used as the resin serving as a binder. In this situation, resin is cured by leaving the mold product at temperatures ranging from room temperatures to relatively low temperatures. As to the hardened mold product, by increasing resin being a non-magnetic material, a core being lower in saturation magnetic flux density and permeability than the powder magnetic core can be easily formed, even when the identical soft magnetic powder used for the powder magnetic core structuring the inner core portion 31 is used.

The hardened mold product may be a mixture of the magnetic powder and the resin serving as a binder, to which a filler made of ceramic such as alumina, silica, calcium carbonate, and glass fibers is added. In this mode, for example, the resin composite such as BMC in which calcium carbonate or glass fibers are mixed into unsaturated polyester can be used as the raw material. Since the BMC has excellent injection moldability, it can contribute toward improving productivity. By mixing the filler of smaller specific gravity as compared to the magnetic powder, the magnetic powder can be suppressed from being unevenly located, and a mold product in which magnetic powder is evenly dispersed can be obtained. Further, when the filler is made of the material with excellent thermal conductivity, it can contribute toward improving the heat dissipating characteristic. Further, since the filler is contained, an improvement in strength and the like can be achieved. When the filler is mixed, the content of the filler may be 0.3 mass percent or more and 30 mass percent or less when the hardened mold product is 100 mass percent, and the total content of the magnetic powder and the filler may be 20 volume percent to 70 volume percent when the hardened mold product is 100 volume percent. When the filler is finer than the magnetic powder, the filler can be blended among the magnetic particles easier. Thus, the magnetic powder can be uniformly dispersed. Furthermore, a reduction in proportion of the magnetic powder because of the contained filler can be suppressed easier.

In particular, when injection molding is used, it is preferable to use, as the raw material, a mixture in which: average particle size of the magnetic powder is 1 μm or more and 200 μm or less, preferably 1 μm or more and 100 μm or less and whose circularity is 1.0 or more and 2.0 or less, preferably 1.0 or more and 1.5 or less; and the content of the magnetic powder of the dividable elements structuring the outer core portion is 30 mass percent or more and 70 mass percent or less, preferably 40 mass percent or more and 60 mass percent or less. In this situation, even when the integrated mold products 321 and 322 are each in a complicated shape, the mixture can be precisely packed in the cavity formed by the bottomed case pieces 41 and 42 and the convex-shape mold assemblies, and the integrated mold products 321 and 322 of high molding precision can be preferably molded. Further, using injection molding, voids can be reduced in number or can be reduced in size. Thus, deterioration of the magnetic characteristic attributed to a great number of voids or voids of great size can be suppressed. When the raw material containing the magnetic powder satisfying the conditions of the average particle size and circularity in the specific range noted above is used, the molding pressure in performing injection molding is suitably 10 MPa to 100 MPa.

Note that, with any of the molding schemes described above including the injection molding, deformation or reduction of the magnetic powder substantially does not occur during manufacture of the hardened mold product, and the shape, size and content of the magnetic powder used as the raw material can be retained. That is, the shape, size and content of the magnetic powder in the hardened mold product are substantially equal to those of the raw material.

The average particle size of the magnetic powder in the hardened mold product can be measured by, for example, removing resin components to extract the magnetic powder, and analyzing the grain size (particle size) of the obtained magnetic powder using a particle size analyzer. Any commercially available particle size analyzer can be used. When the hardened mold product contains the filler stated above, particles should be selected by performing a component analysis through the X-ray diffraction, the energy-dispersive X-ray spectroscopy (EDX) and the like. On the other hand, when the filler is made of a non-magnetic material, particles should be selected by a magnet.

The circularity is defined as: the maximum diameter of the particles structuring magnetic powder/equivalent circle diameter. The equivalent circle diameter is obtained by specifying the contour of each particle structuring the magnetic powder, to obtain the diameter of a circle having the area identical to area S enclosed by the contour. That is, the equivalent circle diameter is expressed as: 2×{area S in the contour/Π}½. Further, the maximum diameter is the maximum length of the particle having such a contour. Area S may be measured through the use of observation images of the cross section of the hardened mold product obtained by an optical microscope or a scanning electron microscope: SEM. Area S in the contour should be calculated by extracting the contour of the particle by subjecting the observation image of the obtained cross section to image processing (e.g., binarizing process) or the like. The maximum diameter may be measured by extracting the maximum length of the particle from the contour of the extracted particle. When an SEM is used, the measurement conditions may be as follows: the number of cross section is 50 pieces or more (one field of view per cross section); magnification is 50 times to 1000 times; the number of measured particles per field of view is 10 or more; and the number of particles in total is 1000 or more.

Herein, for the integrated mold products 321 and 322, the magnetic powder being pure iron powder satisfying the average particle size being 54 μm and the circularity being 1.9 is employed. The content of the magnetic powder (pure iron powder) is 40 mass percent and the binder resin is silicone resin. Further, the integrated mold products 321 and 322 are each formed by injection molding.

Since the integrated mold products 321 and 322 are each an independent member, the material, average particle size, circularity, and content of the magnetic powder structuring the integrated mold products 321 and 322, the presence or absence, material, and content of the filler, the material of the binder resin and the like can be differed between the integrated mold products 321 and 322. That is, the magnetic characteristic can be varied for each of the integrated mold products 321 and 322. For example, when the content of the magnetic powder or the filler of the integrated mold product 322 disposed on the installation target side is greater than that of one integrated mold product 321, the heat dissipating characteristic can be enhanced. In particular, as shown in this example, with the horizontal disposition, a closed magnetic path can be fully formed even when the magnetic powder is unevenly located on the installation target side. Further, when the amount of the magnetic powder of one integrated mold product 321 is small, a reduction in weight of the outer core portion as a whole can be achieved.

Herein, the relative permeability of the outer core portion 32A is 5 to 30 and the saturation magnetic flux density of the outer core portion 32A is 0.5 T or more and less than the saturation magnetic flux density of the inner core portion 31. Further, in the outer core portion 32A, no gap members or air gaps are interposed. Since the relative permeability of the outer core portion 32A is lower than the inner core portion 31, the leakage flux of the magnetic core 3A can be reduced or the gapless structure magnetic core 3A can be obtained. For example, when the blending amount of the magnetic powder is reduced, a hardened mold product with low relative permeability can be obtained.

The saturation magnetic flux density or relative permeability of the inner core portion 31 and the outer core portion 32A can be measured by preparing the sample pieces of the core portions 31 and 32A, and using a commercially available B-H curve tracer or a VSM (Vibrating Sample Magnetometer).

<Case>

One bottomed case piece 41 structuring the case 4 is a quadrangular box-like element including a bottom portion 411 made of a rectangular flat plate and a quadrangular frame-like wall portion 412 provided to stand upright from the bottom portion 411. Other bottomed case piece 42 is in a similar shape, and includes a bottom portion 421 and a wall portion 422. When the bottomed case pieces 41 and 42 are combined with each other, they form a rectangular parallelepiped-shaped container. That is, the case 4 further includes a lid portion in an integrated manner, in contrast to the conventional box-like case. Both the bottomed case pieces 41 and 42 function as holding and protective members for the integrated mold products 321 and 322 structuring the outer core portion 32A described above, and are used as the heat dissipation path.

In consideration of the uses described above, the case 4 is preferably made of a material being excellent in thermal conductivity, and generally made of metal with high thermal conductivity. Further, in order to prevent the case 4 itself from generating a leakage flux, the material of the case 4 is non-magnetic. Specific metal may be aluminum and alloy thereof, and magnesium and alloy thereof. The metals noted above are conductive, and hence can magnetically block the magnetic flux from the stored object. Accordingly, the leakage flux to the outside of the case 4 can be effectively reduced. Further, since the noted metals are lightweight, they are preferable for the uses where being lightweight is desired, such as an automotive component. Further, since metals generally have great strength, the mechanical protection and protection from the environment of the outer core portion 32A and the like can be fully achieved.

Here, the inner circumferential face of each of the bottomed case pieces 41 and 42 is flat as shown in FIGS. 1 (B) and 1 (C), and the front and back surfaces of the bottom portions 411 and 421 and the front and back surfaces of the wall portions 412 and 422 are substantially formed by flat surfaces, and the integrated mold products 321 and 322 are in contact with the entire surface thereof. On the other hand, for example, part of the coil mold product 2A may be exposed from the outer core portion, and in the coil mold product 2A, the exposed portion may be brought into contact with the bottomed case pieces 41 and 42. When the coil mold product 2A is directly brought into contact with the case 4, the resin structuring the resin mold portion 20 is interposed between the coil 2 and the case 4. Hence, in this mode, excellent insulation is achieved. Herein, the integrated mold products 321 and 322 should be molded such that the inner circumferential faces of the bottomed case pieces 41 and 42 are partially exposed. Further, in this mode, when the coil 2 is used as it is or when part of the coil 2 is not covered by the resin mold portion 20 but exposed, insulation can be enhanced by interposing an insulating member such as an insulating paper, an insulating sheet, an insulating tape, and an insulating adhesive agent between the coil 2 and the case 4 (the bottomed case pieces 41 and 42). The smaller thickness of this insulating member (a total thickness when a multilayer structure is employed) can enhance the heat dissipating characteristic, so long as a prescribed insulating performance is secured, and the thickness may be less than 2 mm, further 1 mm or less, and particularly 0.5 mm or less.

As described above, in the mode in which the coil mold product 2A is in contact with the case 4 (the bottomed case pieces 41 and 42), since the distance from the coil 2 to the case 4 becomes short, the heat dissipating characteristic can be enhanced. In this mode, when the concave and convex portion corresponding to the contact portion of the coil mold product 2A is provided to part of the inner circumferential faces of the bottomed case pieces 41 and 42, the contact area in the coil mold product 2A relative to the case 4 can be increased, whereby the heat dissipating characteristic can be further enhanced. Further, in this mode, the coil mold product 2A can be easily positioned relative to the core-case integrated members 11 and 12.

Alternatively, minor concave and convex may be provided to at least part of the inner circumferential faces of the bottom portions 411 and 421 and the wall portions 412 and 422, in the area of preferably 50 area percent or more, and further preferably 80 area percent or more. The minor concave and convex may have, for example, a maximum height of 1 mm or less, preferably 0.5 mm or less. Since such minor concave and convex are provided, in molding the outer core portion 32A (the integrated mold products 321 and 322), the contact area between the mixture of raw material and the bottomed case pieces 41 and 42 can be increased. Accordingly, even when the resin shrinks while the resin in the mixture of the raw material cures, the integrated mold products 321 and 322 do not easily come off from the bottomed case pieces 41 and 42, and adhesion between the integrated mold products 321 and 322 and the bottomed case pieces 41 and 42 can be enhanced. The surface roughening treatment for providing the minor concave and convex can be carried out by shot blasting, sand blasting, or delustering treatment with sodium hydroxide. When the case 4 is made of aluminum or alloy thereof, aluminum anodizing or the like can be used.

One bottomed case piece 41 is disposed such that the surface (the bottom face) of the bottom portion 411 is parallel to the surface of the installation target. Herein, the surface is disposed on the far side from (above) the installation target. That is, the bottom portion 411 of the bottomed case piece 41 functions as sort of a lid, and can prevent the stored object from coming off. At appropriate positions of the bottom portion 411, the wire holes 41h penetrating through the bottom portion 411 are provided, and the end portions of the wire 2w of the coil 2 are drawn out.

Other bottomed case piece 42 is disposed such that the surface of the bottom portion 421 is parallel to the surface of the installation target. Herein, the surface is disposed to be in contact with the installation target. That is, the surface of the bottom portion 421 of the bottomed case piece 42 functions as the bottom face (the installation face), being the cooling face cooled by the installation target such as a cooling table. Further, the bottomed case piece 42 is provided with fixing portions 46 for fixing the case 4 to the installation target. The fixing portions 46 project outward from the outer circumferential face of the wall portion 422 of the bottomed case piece 42, and are each provided with a bolt hole into which a bolt (not shown) is inserted.

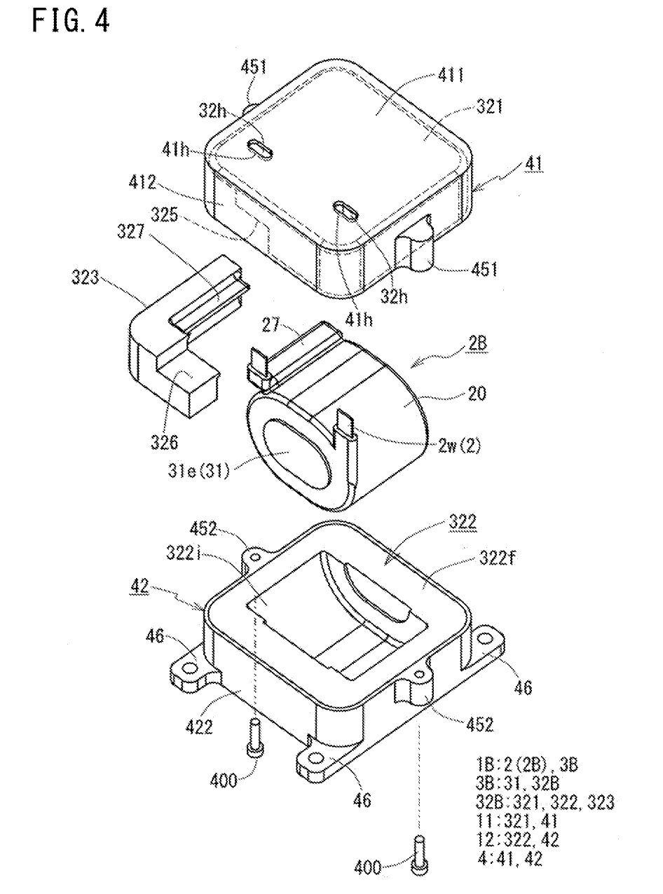

The bottomed case pieces 41 and 42 are integrated by bolts 400 herein. The bottomed case pieces 41 and 42 include attaching portions 451 and 452 projecting outward from the periphery of the opening of the wall portions 412 and 422, and bolts 400 are inserted into the attaching portions 451 and 452. The attaching portions 451 have through holes with which the bolts 400 are not screwed, while the attaching portions 452 have threaded through holes with which the bolts 400 are screwed. The through holes of the attaching portions 451 are each an elongated hole slightly greater than each through hole of the attaching portions 452, and the bottomed case pieces 41 and 42 can be fixed without the necessity of exactly positioning the core-case integrated members 11 and 12. Hence, excellent workability is exhibited. The shape, position, and number of pieces of the attaching portions 451 and 452 are not particularly limited. For example, as in the following second embodiment (FIG. 4), one of the attaching portions may be provided with a blind hole (see attaching portions 451 in FIG. 4) instead of the through hole. Further, the direction of attaching the bolts 400 are not particularly limited also. Though they are attached from above toward the bottom in the first embodiment, the bolts 400 are attached from below toward the top in the second embodiment.

The aforementioned bottomed case pieces 41 and 42 can be easily manufactured by casting or cutting work. Further, the aforementioned surface roughening treatment can be performed as appropriate.

[Other Stored Object]

In addition, a physical quantity measuring sensor (not shown) such as a temperature sensor and a current sensor can be included. In this mode, at least one of the bottomed case pieces 41 and 42 and the outer core portion 32A is provided with a line-use hole (not shown) or a line-use cutout (not shown) through which a line connected to the sensor is drawn out.

[Uses]

The reactor 1A structured as described above can be suitably used where the energizing conditions are, for example: the maximum current (direct current) is approximately 100 A to 1000 A; the average voltage is 100 V to 1000 V; and the working frequency is 5 kHz to 100 kHz. Representatively, the reactor 1A can be suitably used as a constituent component of an in-vehicle power converter apparatus for an electric vehicle, a hybrid vehicle, a fuel cell vehicle and the like.

[Method for Manufacturing Reactor]

The reactor 1A can be manufactured as follows, for example. Firstly, as shown in FIG. 2, the inner core portion 31 made of the coil 2 and the powder magnetic core are prepared. Then, the coil mold product 2A in which the coil 2 and the inner core portion 31 are integrally retained by the resin mold portion 20 as described above is produced. Further, by injection molding or the like, the integrated mold products 321 and 322 structuring the outer core portion 32A are molded to the bottomed case pieces 41 and 42, to produce the core-case integrated members 11 and 12.

The coil mold product 2A is stored in the integrated mold product 322 of the core-case integrated member 12 disposed on the installation target side. Since the contact face 322i of the integrated mold product 322 is in the shape conforming to the outer shape of the coil mold product 2A, the coil mold product 2A can be easily positioned, and furthermore, the coil mold product 2A can be retained.

One core-case integrated member 11 having the wire holes 32h and 41h is disposed from above the coil mold product 2A stored in the core-case integrated member 12. Here, the end portions of the wire 2w are inserted into the wire holes 32h and 41h. The integrated mold products 321 and 322 can be precisely combined with each other, employing the engaging portion (the engaging projections 33 and the engaging holes 34) as the guide. By assembling the coil mold product 2A and the integrated mold products 321 and 322 to each other, the outer core portion 32A is formed. Further, the end faces of the coil mold product 2A are covered by part of the contact faces 321i and 322i of the integrated mold products 321 and 322, and the outer circumferential face of the coil mold product 2A is covered by other portion of the contact faces 321i and 322i of the integrated mold products 321 and 322. That is, the end faces 31e of the inner core portion 31 are brought into contact with the contact faces 321i and 322i of the integrated mold products 321 and 322, and the magnetic core 3A is formed. Note that, the opposing faces 321f and 322f of the integrated mold products 321 and 322 may be joined to each other by an adhesive agent. Further, solely one of the coil mold product 2A and the inner core portion 31 may be joined to the outer core portion 32A by an adhesive agent.

Further, by fastening the attaching portions 451 and 452 of the bottomed case pieces 11 and 12 by the bolts 400, the case 4 is formed and the reactor 1A is obtained.

[Effects]

The reactor 1A includes the outer core portion 32A being a hardened mold product, and includes the case 4 made of non-magnetic metal. Further, since the case 4 is made of a pair of bottomed case pieces 41 and 42, the case pieces 41 and 42 can be used as the mold assembly of the outer core portion 32A, and excellent adhesion between the outer core portion 32A and the case 4 can be exhibited. Therefore, the reactor 1A can fully use the case 4 as the heat dissipation path, and an excellent heat dissipating characteristic is exhibited.

Further, since the reactor 1A has the outer core portion 32A integrally molded with the bottomed case pieces 41 and 42, the outer core portion 32A is also in a dividable structure. Accordingly, the manufacturing time per dividable element (the integrated mold products 321 and 322) structuring the outer core portion 32A can be shortened. Further, for example, a pair of core-case integrated members 11 and 12 can be manufactured simultaneously. Further, manufacturing a hardened mold product through injection molding using a raw material of a particular specification, even the integrated mold products 321 and 322 of complicated shapes can be easily molded, and the manufacturing time of the integrated mold products 321 and 322 can be further reduced. Still further, with the reactor 1A, since the division number of the outer core portion 32A and the case 4 is minimized, i.e., two, the time required for the combining work is also short. Thanks to these points, the reactor 1A also exhibits excellent productivity. Further, the reactor 1A is expected to be suitable for mass production.

In particular, the reactor 1A is in the horizontal disposition when installed on the installation target. Accordingly, the distance between the coil 2 and the installation target is short, and furthermore, the thickness in the region of the outer core portion 32A on the installation target side is small. Further, with the reactor 1A, the end face shape of the coil 2 is in a racetrack shape, that is, in the shape where the distance from the coil 2 to the installation target is short in many regions of the coil 2. Thanks also to these points, the reactor 1A exhibits an excellent heat dissipating characteristic.

Further, with the reactor 1A, the coil 2 can be handled easier thanks to use of the coil mold product 2A. In particular, since the coil mold product 2A in which the inner core portion 31 is also integrally retained is used, the reactor 1A is structured by three components, i.e., the coil mold product 2A, and the core-case integrated members 11 and 12. Accordingly, the number of steps of assembly and the number of components can be reduced. Thanks also to these points, the reactor 1A exhibits excellent productivity.

In addition, with the reactor 1A, since the outer core portion 32A is in a dividable structure, and the integrated mold products 321 and 322 are the hardened mold products, the following effects are also achieved: (1) the magnetic characteristic of the integrated mold products 321 and 322 can be easily changed; and (2) since the resin component is included, protection from the external environment and mechanical protection for the coil mold product 2A and the inner core portion 31 can be achieved. Further, since the outer core portion 32A is in a dividable structure, as compared to the situation where the outer core portion 32A is structured by one hardened mold product, the presence state (density) of the magnetic powder will not vary easily thanks to the small size of each dividable element, and a uniform magnetic characteristic can be obtained. Accordingly, the reactor 1A exhibits an excellent magnetic characteristic.

With the reactor 1A, the outer core portion 32A is divided in the radial direction of the coil 2. In particular, the integrated mold products 321 and 322 are divided such that part of their seam portion, specifically the portion of the seam portion that is disposed on the end face side of the coil 2, is disposed in the radial direction of the coil 2. Other portion of the seam portion, specifically the portion disposed on the outer circumferential face side of the coil 2, is disposed in parallel to the axial direction of the coil 2. Accordingly, with the reactor 1A, gaps that break the magnetic flux do not occur between the integrated mold products 321 and 322 structuring the outer core portion 32A. Thanks to this point also, an excellent magnetic characteristic is exhibited. Further, since the integrated mold products 321 and 322 each have a Π-shaped cross section, the magnetic flux is allowed to pass from one end face side of the coil to other end face side via the outer circumferential face side of the coil. This also contributes to an excellent magnetic characteristic. Note that, the “radial direction of the coil” is the direction of any straight line that passes through the center at the end face of the coil (the point on the axis of the coil).

The reactor 1A also exhibits an excellent insulating performance, because the resin structuring the resin mold portion 20 is present between the coil 2 and the magnetic core 3A, the case 4 and the like. In particular, with the reactor 1A, since the drawn out portions of the wire 2w structuring the coil 2 are also covered by the resin mold portion 20, insulation between the drawn out portions and the outer core portion 32A can be secured.

Since the reactor 1A has one coil 2 and is in the horizontal disposition, it does not occupy a large space and is small in size. Further, the reactor 1A is small in size thanks also to the coil 2 being an edgewise coil whose space factor is great and whose size can be easily reduced. Further, since the saturation magnetic flux density of the inner core portion 31 is higher than that of the outer core portion 32A, in obtaining the magnetic flux identical to that produced by a magnetic core made of a single material and the saturation magnetic flux density as a whole is uniform, the cross-sectional area (the plane where the magnetic flux passes) of the inner core portion 31 can be made small. Thanks to this point also, the reactor 1A is small in size. Additionally, with the reactor 1A, the size is reduced also by elimination of any gap. Furthermore, any loss attributed to the gap can be reduced.

With the reactor 1A, since the inner core portion 31 is a powder magnetic core, the following effects are also achieved: (1) even a complicated three-dimensional shape can be formed with ease, and hence excellent productivity is achieved; and (2) the magnetic characteristic such as a saturation magnetic flux density can be adjusted with ease.

### Second Embodiment

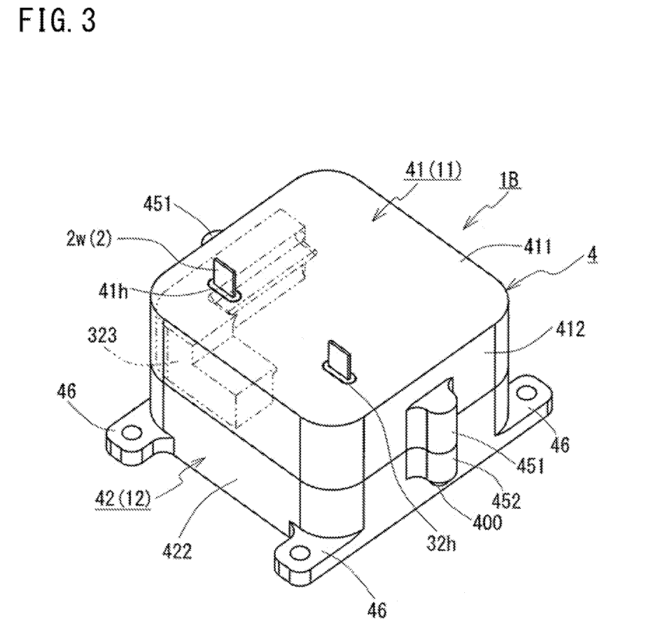

In the following, with reference to FIGS. 3 to 5, a description will be given of a reactor 1B according to the second embodiment. The basic structure of the reactor 1B is similar to the reactor 1A according to the first embodiment, and the main constituent members are a coil mold product 2B (see FIG. 4) retaining the inner core portion 31, and a pair of core-case integrated members 11 and 12. However, the reactor 1B is different from the reactor 1A according to the first embodiment in that: out of the two integrated mold products 321 and 322 (see FIG. 4) structuring the outer core portion 32B (FIG. 4), one integrated mold product 321 is only partially molded relative to the entire inner circumferential face of the bottomed case piece 41, and an independent core piece 323 that can be fitted to the integrated mold product 321 is included; and that the disposition place of one end portion of the wire 2w structuring the coil 2 is different. In the following, a description will be given focusing on the differences, and the detailed description as to the structure and effects being similar to those of the first embodiment will not be given.

With the coil 2 according to the first embodiment, the end portions of the wire 2w are different from each other in the disposition position in the axial direction of the coil 2, and the end portions are respectively disposed on the end face sides of the coil 2. With the coil 2 according to the second embodiment, one end portion of the wire 2w is folded back toward other end portion. The opposite end portions of the wire 2w are equal to each other in the disposition position in the axial direction of the coil, and the opposite end portions are juxtaposed to each other at around one end face of the coil 2. This folded back portion projects further than the turn forming face of the coil 2. Accordingly, the coil mold product 2B included in the reactor 1B according to the second embodiment is provided with, as shown in FIG. 4, an overhanging portion 27 in which the portion projecting from the turn forming face of the coil 2 is covered by the resin structuring the resin mold portion 20.

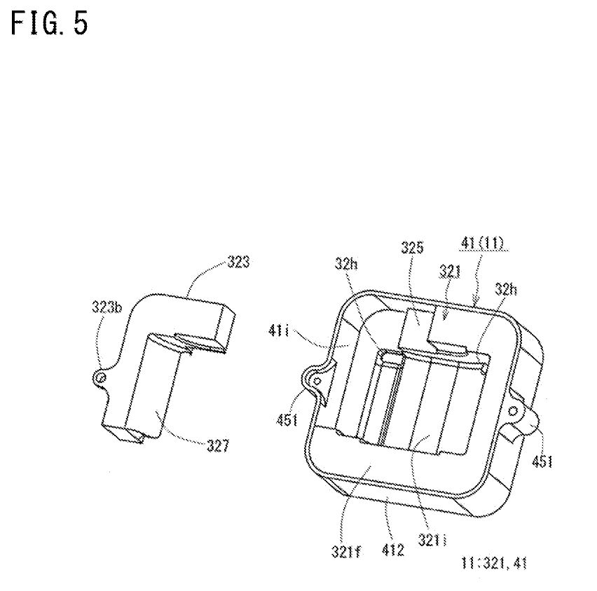

With the reactor 1B, in the outer core portion 32B, as shown in FIG. 5, the integrated mold product 321 including the wire holes 32h from which the end portions of the wire 2w of the coil 2 are drawn out is molded such that the inner wall face 41i of the wall portion 412 in the bottomed case piece 41 is partially exposed. Herein, the integrated mold product 321 is cut out in an L-shape, in which one corner of the wall portion 412 is included. In this cut out portion, the L-shaped independent core piece 323 is assembled, to form the shape similar to the integrated mold product 321 included in the reactor 1A according to the first embodiment. That is, the magnetic core 3B included in the reactor 1B includes the inner core portion 31 and the outer core portion 32B structured by the two integrated mold products 321 and 322 and the independent core piece 323.

As shown in FIG. 4, the independent core piece 323 includes a wire-use projecting portion 327 where the overhanging portion 27 of the coil mold product 2B is disposed. Thanks to the wire-use projecting portion 327, the magnetic component (the outer core portion 32B) can exist below the overhanging portion 27 also, and substantially the entire outer surface of the coil mold product 2B can be covered by the outer core portion 32B. Further, since the integrated mold product 321 molded in the bottomed case piece 41 and the independent core piece 323 can be separated from each other, the wire-use projecting portion 327 can be easily disposed below the overhanging portion 27.

The independent core piece 323 can be joined to the bottomed case piece 41 by an adhesive agent or the like. Alternatively, the independent core piece 323 may include an attaching portion 323b (FIG. 5) provided with a bolt hole through which the bolt 400 fastening the bottomed case pieces 41 and 42 penetrates. As shown in FIG. 5, one attaching portion 451 of the bottomed case piece 41 has a space where the attaching portion 323b of the independent core piece 323 can be fitted into.

In addition, herein, as shown in FIG. 4, the contact faces between the integrated mold product 321 and the independent core piece 323 are provided in a stepwise manner. These stepwise faces, i.e., engaging step portions 325 and 326, function as the engaging portions of the integrated mold product 321 and the independent core piece 323, and the integrated mold product 321 and the independent core piece 323 can be easily positioned. When the integrated mold product 321 and the independent core piece 323 are combined with each other, part of the seam portion, specifically the portion disposed on the end face side of the coil 2, becomes stepwise by the engaging step portions 325 and 326. The shape of the engaging portions can be selected as appropriate. For example, the engaging projections 33 and the engaging holes 34 according to the first embodiment described above can be used. As in this example, when the engaging portions are formed by flat surfaces, the shape of the integrated mold product 321 and the independent core piece 323 can be simplified, and hence excellent moldability is achieved. Alternatively, no engaging portions may be included.

Note that, the integrated mold product 321 included in one core-case integrated member 11 and the integrated mold product 322 included in other core-case integrated member 12 each include, similarly to the first embodiment, the portions covering part of (herein, half) the end faces of the coil 2 and the portion covering part of (herein, half the circumference) the outer circumferential face of the coil 2.

The reactor 1B according to the second embodiment is assembled as follows. Similarly to the first embodiment, the coil mold product 2B is fitted to the integrated mold product 322 of the core-case integrated member 12. Next, the independent core piece 323 is assembled thereto. The independent core piece 323 is hooked on the coil mold product 2B, and held by the opposing face 322f of the integrated mold product 322. Next, similarly to the first embodiment, from above the coil mold product 2B, one core-case integrated member 11 is disposed, and the opposite end portions of the wire 2w are inserted into the wire holes 32h and 41h. At the same time, the attaching portion 323b of the independent core piece 323 is stored in one attaching portion 451 of the bottomed case piece 41. Then, similarly to the first embodiment, by allowing the attaching portions 451 and 452 of the bottomed case pieces 41 and 42 to be fastened by the bolts 400, the case 4 is formed, and the reactor 1B is obtained.

The reactor 1B according to the second embodiment also exhibits an excellent heat dissipating characteristic, and can be manufactured highly productively. In particular, since the reactor 1B includes the independent core piece 323, substantially the entire surface of the coil mold product 2B can be covered by the outer core portion 32B. In this manner, by using at least one independent core piece, the outer core portion can be disposed to cover the entire surface of the coil of any shape.

In addition, with the reactor 1B according to the second embodiment, in the seam portion formed by one integrated mold product 321 and the independent core piece 323 structuring the outer core portion 32B, the portion disposed on the outer circumferential face side of the coil 2 is present to break the magnetic flux. However, similarly to the first embodiment, other integrated mold product 322 substantially does not break the magnetic flux. Further, the seam portion formed by the integrated mold products 321 and 322 substantially does not break the magnetic flux, similarly to the first embodiment. Accordingly, the reactor 1B according to the second embodiment also involves only a small number of gaps among the divided pieces structuring the outer core portion 32B that break the magnetic flux, and hence an excellent magnetic characteristic is exhibited.

(Variation 1)

According to the first and second embodiments, two core-case integrated members 11 and 12 are included. However, three core-case integrated members may be included. In this mode, similarly to the first embodiment, two core-case integrated members each having a ]-shaped cross section, and further a frame-like member (e.g., a quadrangular frame-like member) interposed between the core-case integrated members each having a Π-shaped cross section are included. The frame-like member includes a frame-like case piece serving as a divided case piece structuring part of the case, and a frame-like core piece structuring part of the outer core portion and integrally molded with the frame-like case piece. Thus, increasing the number of pieces of the core-case integrated members, size of each member is reduced. Therefore, even when cast molding is employed in molding the dividable elements structuring the outer core portion, the manufacturing time can be shortened. Further, when the number of division of the outer core portion is great, it becomes possible to employ the mode in which the magnetic characteristic of the cores is varied stepwise. Further, since the frame-like member also includes the divided case piece (the frame-like core piece) made of non-magnetic metal, excellent strength is obtained as compared to the situation where only a hardened mold product is included, and excellent handleability is exhibited.

(Variation 2)

According to the first and second embodiments, in the seam portion of the core-case integrated members (=the seam portion of the integrated mold product=the seam portion of the bottomed case piece), the portion disposed on the end face side of the coil is disposed along the major axis. However, it may be disposed along the minor axis. In this mode, when the horizontal disposition is employed, since the core-case integrated members can be separated in the major axis direction, part of the seam portion of the integrated member is disposed on the installation target.

Alternatively, in the seam portion of the core-case integrated members, the portion disposed on the end face side of the coil may be disposed along a radial direction other than the major axis and the minor axis. In this mode, part of the seam portion, specifically the portion disposed on the end face side of the coil is disposed in the radial direction (other than the major axis and the minor axis) of the coil, and other portion of the seam portion, specifically the portion disposed on the outer circumferential face side of the coil, is disposed in parallel to the axial direction of the coil similarly to the first and second embodiments. Thus, gaps breaking the magnetic flux substantially do not occur in the outer core portion. When the reactor is disposed on the installation target, part of the seam portion is disposed to cross the surface of the installation target, while other part of the seam portion is disposed in parallel to the surface of the installation target.

(Variation 3)

In the first and second embodiments, the horizontal disposition is employed, in which the axial direction of the coil 2 is parallel to the surface of the installation target. However, it is also possible to employ the mode as described in Patent Literature 2, in which the coil is disposed such that the axial direction of the coil is perpendicular to the surface of the installation target (hereinafter referred to as the vertical disposition). The vertical disposition can reduce the installation area. In the vertical disposition, employing the mode in which the core-case integrated members can be separated in the radial direction of the coil 2, part of the seam portion of the integrated member is disposed on the installation target; employing the mode in which the core-case integrated members can be separated in the direction perpendicular to the axial direction of the coil 2, part of the seam portion is prevented from being disposed on the installation target.

(Variation 4)

According to the first and second embodiments, the coil mold products 2A and 2B are included. However, the coil 2 can be used as it is. Alternatively, for example, applying an insulating tape or disposing an insulating paper or an insulating sheet at the outer surface of the coil 2 and the inner core portion 31, an insulating member can be interposed between the coil 2 and the magnetic cores 3A and 3B. Alternatively, when an insulator made of an insulating material being identical to the constituent material structuring the bobbins 21 is provided at the outer circumference of the inner core portion 31, insulation between the coil 2 and the inner core portion 31 can be enhanced. The insulator may be a sleeve-like element covering the outer circumference of the inner core portion 31, or may include the sleeve-like element and a flange portion (e.g., an annular piece) projecting toward the outside from each of the opposite edge portions of the sleeve-like element. When the sleeve-like element is a divided piece that can be divided in the radial direction of the coil 2, it can be easily disposed on the outer circumference of the inner core portion 31. Further, the sleeve-like element can be used for positioning the inner core portion 31 with respect to the coil 2.

(Variation 5)

According to the first and second embodiments, one sleeve-like coil 2 is included. However, a pair of coil elements can be included. What are included in this mode are: a coil including a pair of sleeve-like coil elements juxtaposed to each other such that their respective axes are paralleled; and a magnetic core having a pair of inner core portions disposed inside the coil elements and outer core portions disposed outside the coil elements. The magnetic core is structured in an annular shape, by the outer core portions being connected so as to connect between the juxtaposed inner core portions. For example, similarly to the first and second embodiments, when a pair of halved bottomed case pieces is included, the integrated mold product included in each of the bottomed case pieces may have a Π-shaped vertical cross section and a Π-shaped horizontal cross section, as in the first and second embodiments. In this mode, similarly to the first and second embodiments, the outer core portion can be disposed on each of the end face side and the outer circumferential face side of the coil. Alternatively, the integrated mold product included in each of the bottomed case pieces may be a columnar element of a rectangular parallelepiped-shape or the like. At each of the inner wall faces of a pair of wall portions disposed so as to oppose to each other in each bottomed case piece, this columnar integrated mold product is molded. The two integrated mold products clamp the juxtaposed inner core portions. In this mode, the outer core portions are arranged at least on the end face sides of the coil to be in contact with the inner core portions, thereby forming a closed magnetic path. In any mode, the material of the outer core portions can be partially varied.

### Embodiment I

The reactor according to any of the first and second embodiments and Variations 1 to 5 may be used, for example, as a constituent component of a converter mounted on a vehicle or the like, or as a constituent component of a power converter apparatus including the converter.

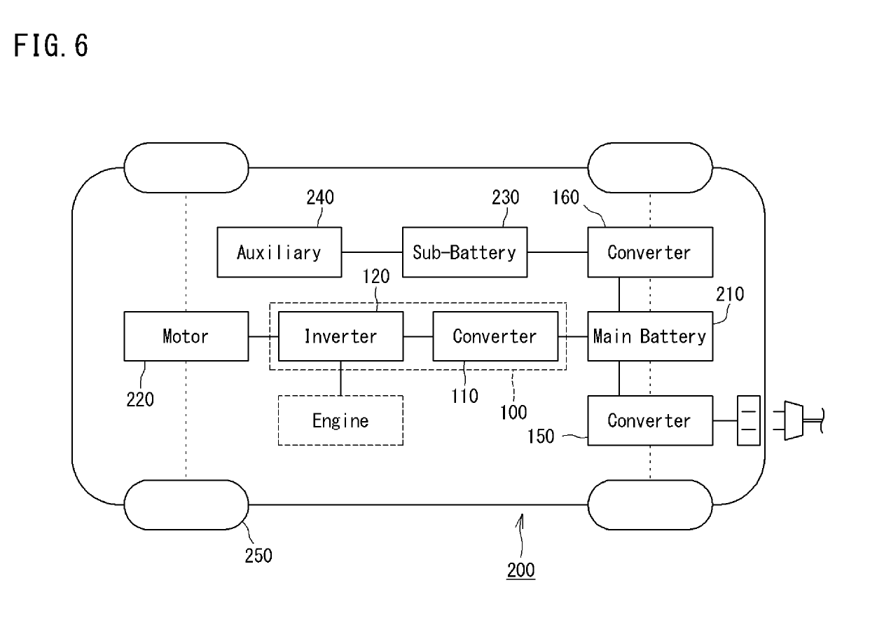

For example, as shown in FIG. 6, a vehicle 200 such as a hybrid vehicle or an electric vehicle includes a main battery 210, a power converter apparatus 100 connected to the main battery 210, and a motor (load) 220 driven by power supplied from the main battery 210 and serves for traveling. The motor 220 is representatively a three-phase alternating current motor. The motor 220 drives wheels 250 in the traveling mode and functions as a generator in the regenerative mode. When the vehicle is a hybrid vehicle, the vehicle 200 includes an engine in addition to the motor 220. Though an inlet is shown as a charging portion of the vehicle 200 in FIG. 6, a plug may be included.

The power converter apparatus 100 includes a converter 110 connected to the main battery 210 and an inverter 120 connected to the converter 110 to perform interconversion between direct current and alternating current. When the vehicle 200 is in the traveling mode, the converter 110 in this example steps up DC voltage (input voltage) of approximately 200 V to 300 V of the main battery 210 to approximately 400 V to 700 V, and supplies the inverter 120 with the stepped up power. Further, in the regenerative mode, the converter 110 steps down DC voltage (input voltage) output from the motor 220 through the inverter 120 to DC voltage suitable for the main battery 210, such that the main battery 210 is charged with the DC voltage. When the vehicle 200 is in the traveling mode, the inverter 120 converts the direct current stepped up by the converter 110 to a prescribed alternating current and supplies the motor 220 with the alternating current. In the regenerative mode, the inverter 120 converts the AC output from the motor 220 into direct current, and outputs the direct current to the converter 110.

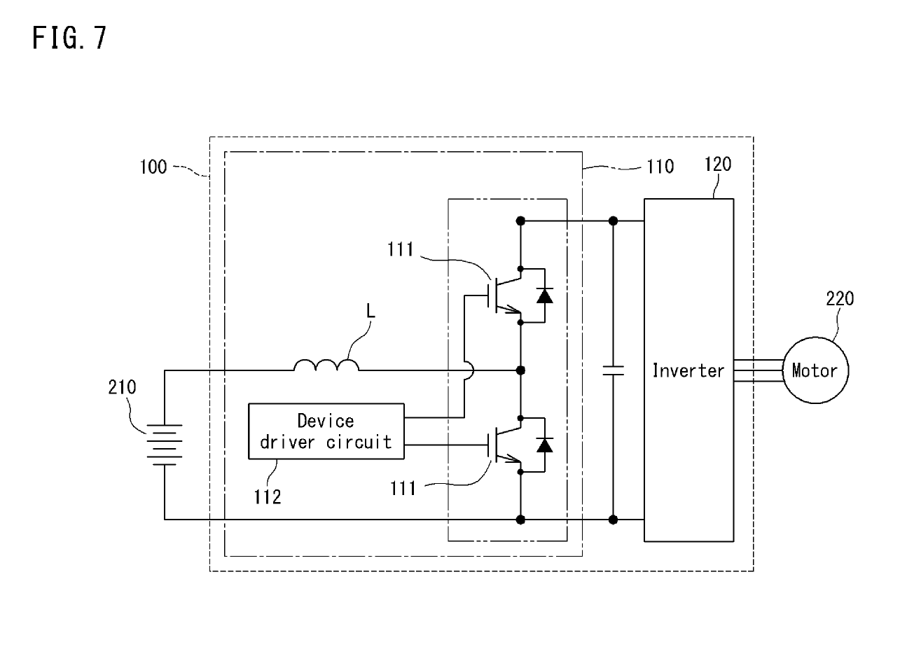

As shown in FIG. 7, the converter 110 includes a plurality of switching elements 111, a driver circuit 112 that controls operations of the switching elements 111, and a reactor L. The converter 110 converts (here, performs step up and down) the input voltage by repetitively performing ON/OFF (switching operations). As the switching elements 111, power devices such as FETs and IGBTs are used. The reactor L uses a characteristic of a coil that disturbs a change of current which flows through the circuit, and hence has a function of making the change smooth when the current is increased or decreased by the switching operation. The reactor L is the reactor according to any of the first and second embodiments and Variations 1 to 5. Since the reactor with excellent heat dissipating characteristic and productivity is included, the power converter apparatus 100 and the converter 110 exhibit excellent heat dissipating characteristic and productivity.

The vehicle 200 includes, in addition to the converter 110, a power supply apparatus-use converter 150 connected to the main battery 210, and an auxiliary power supply-use converter 160 connected to a sub-battery 230 serving as a power supply of auxiliary equipment 240 and to the main battery 210, to convert a high voltage of the main battery 210 to a low voltage. The converter 110 representatively performs DC-DC conversion, whereas the power supply apparatus-use converter 150 and the auxiliary power supply-use converter 160 perform AC-DC conversion. Some types of the power supply apparatus-use converter 150 perform DC-DC conversion. The power supply apparatus-use converter 150 and the auxiliary power supply-use converter 160 each may be structured similarly to the reactor according the first and second embodiments and Variations 1 to 5, and the size and shape of the reactor may be changed as appropriate. Further, the reactor according to any of the foregoing first and second embodiments and Variations 1 to 5 may be used as a converter that performs conversion for the input power and that performs only stepping up or stepping down.

Note that the present invention is not limited to the embodiments described above, and can be practiced as being modified as appropriate within a range not departing from the gist of the present invention.

### INDUSTRIAL APPLICABILITY

The reactor of the present invention can be suitably used as any of various types of reactors (an in-vehicle component, a component of power generating plants and substation facilities and the like). In particular, the reactor of the present invention can be used as a constituent component of a power converter apparatus, such as a DC-DC converter mounted on a vehicle such as a hybrid vehicle, an electric vehicle, a fuel cell vehicle and the like. The converter of the present invention and the power converter apparatus of the present invention can be used in various fields, such as in-vehicle devices, power generating plants and substation facilities.

### REFERENCE SIGNS LIST

1A, 1B: REACTOR
2A, 2B: COIL MOLD PRODUCT
11, 12: CORE-CASE INTEGRATED MEMBER
2: COIL
2w: WIRE
20: RESIN MOLD PORTION
21: BOBBIN
27: OVERHANGING PORTION
3A, 3B: MAGNETIC CORE
31: INNER CORE PORTION
31e: END FACE
32A, 32B: OUTER CORE PORTION
321, 322: INTEGRATED MOLD PRODUCT
323: INDEPENDENT CORE PIECE
323b: ATTACHING PORTION
321f, 322f: OPPOSING FACE
321i, 322i: CONTACT FACE
32h, 41h: WIRE HOLE
33: ENGAGING PROJECTION
34: ENGAGING HOLE
325, 326: ENGAGING STEP PORTION
327: WIRE-USE PROJECTING PORTION
4: CASE
41, 42: BOTTOMED CASE PIECE
411, 421: BOTTOM PORTION
412, 422: WALL PORTION
41i: INNER WALL FACE
451, 452: ATTACHING PORTION
400: BOLT
46: FIXING PORTION
100: POWER CONVERTER APPARATUS
110: CONVERTER
111: SWITCHING ELEMENT
112: DRIVER CIRCUIT
120: INVERTER
150: POWER SUPPLY APPARATUS-USE CONVERTER
160: AUXILIARY POWER SUPPLY-USE CONVERTER
200: VEHICLE
210: MAIN BATTERY
220: MOTOR
230: SUB-BATTERY
240: AUXILIARY EQUIPMENT
250: WHEELS

1. A reactor comprising:
a sleeve-like coil;
a magnetic core that has an inner core portion disposed inside the coil and an outer core portion disposed outside the coil, the outer core portion forming a closed magnetic path with the inner core portion; and
a case that stores the coil and the magnetic core, wherein
the case is structured by a combination of a plurality of divided case pieces made of a non-magnetic metal,
two of the plurality of divided case pieces are each a bottomed sleeve-like bottomed case piece,
the outer core portion is a mold product of a mixture of magnetic powder and resin, and
the outer core portion includes integrated mold products respectively integrally molded with the bottomed case pieces.

2. The reactor according to claim 1, wherein
the bottomed case pieces can be separated in a radial direction of the coil.

3. The reactor according to claim 2, wherein
the sleeve-like coil is included by one in number, and
at least one of the integrated mold products includes portions that partially cover end faces of the coil, and a portion that partially covers an outer circumferential face of the coil.

4. The reactor according to claim 1, wherein
the outer core portion includes an independent core piece that can be fitted to the integrated mold product.

5. A converter comprising:
a switching element;
a driver circuit that controls an operation of the switching element; and
a reactor that smoothes a switching operation, wherein
the converter converts an input voltage by the operation of the switching element, and
the reactor is the reactor according to claim 1.

6. A power converter apparatus comprising:
a converter that converts an input voltage; and
an inverter that is connected to the converter and that performs interconversion between a direct current and an alternating current, wherein
the power converter apparatus drives a load by power obtained by conversion of the inverter, and
the converter is the converter according to claim 5.
